(19) United States
(12) Patent Application Publication
(10) Pub. No.: US 2026/0328333 A1
(43) Pub. Date: Oct. 22, 2026

(54) Mirror Mount and Stand

(71) Applicant: LFBS LLC, Albuquerque, NM (US)

(72) Inventor: Filipe Joaquim Nunes Da Silva, Sofia (BG)

(21) Appl. No.: 19/631,177

(22) Filed: Mar. 27, 2026

Related U.S. Application Data
(63) Continuation of application No. 19/448,046, filed on Jan. 13, 2026.

(30) Foreign Application Priority Data
Jan. 16, 2025 (EM) 015090313-0001

(51) Int. Cl. F16M 11/04; A47G 1/16; F16M 11/28

(52) U.S. Cl. CPC F16M 11/041; A47G 1/16; F16M 11/28

(57) ABSTRACT

A mirror mount is disclosed. The mount has a wall, a plurality of hooks, and a socket. The wall is configured to contact a mirror back. The plurality of hooks are on a front side of the wall. The socket is behind the wall and configured to connect to a stand. A stand having the mount is disclosed.

This application is a continuation application of U.S. patent application Ser. No. 19/448,046, filed Jan. 13, 2026, which is hereby incorporated by reference, and which claimed priority to European Community Design Application no. 015090313-0001, filed Jan. 16, 2025.

### FIELD OF THE INVENTION

This invention relates in general to a mount and a stand for a mirror.

### BACKGROUND OF THE INVENTION

A mirror may be used by a user to view one's self or another person or object. While a mirror may be attached to a wall, the present inventors recognized the need for more freedom in positioning a mirror. The present inventors recognized the need for a mount for supporting a mirror on a stand and a stand for supporting a mirror.

### SUMMARY OF THE INVENTION

A mirror mount is disclosed. In some embodiments the mount has a wall, a plurality of hooks, and a socket. The wall is configured to contact a back of a mirror. The plurality of hooks are on a front side of the wall. The socket is behind the wall and configured to connect to a stand.

A stand having the mount is disclosed. The stand has a base and a post supported by the base. The post is received in the socket of the mount.

A method of mounting a mirror to a stand is disclosed. The plurality of hooks of the mount of the stand are placed in a plurality of receptacles in a back of a mirror. The back of the mirror is placed against the wall of the mount. The mirror is retained on the hooks by engaging a retainer clip of the mount opposite the hooks with the back of the mirror.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a perspective view of an embodiment of a mirror mount of the invention.

FIG. 2 is a rear view of the mount of FIG. 1.

FIG. 3 is a front view of the mount of FIG. 1.

FIG. 4 is a front perspective view of the mount of FIG. 1.

FIG. 5 is a side view of the mount of FIG. 1.

FIG. 6 is a top view of the mount of FIG. 1.

FIG. 7 is a bottom view of the mount of FIG. 1.

FIG. 8 is a perspective view of the mount of FIG. 1 deployed to mount a mirror to a stand.

FIG. 9 is a rear view of the mount of FIG. 1 deployed on the mirror and connected to the stand of FIG. 8.

FIG. 10 is a front view of the mirror and a portion of the stand of FIG. 8.

FIG. 11 is a rear view of a portion of the mount and the mirror taken from FIG. 9.

FIG. 12 is a side view of the mount deployed on the mirror and connected to the stand of FIG. 8.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, this description describes and the drawings show specific embodiments of the invention with the understanding that the present disclosure is to be considered as an exemplification of the principles of the invention and is not intended to limit the invention to the specific embodiments illustrated.

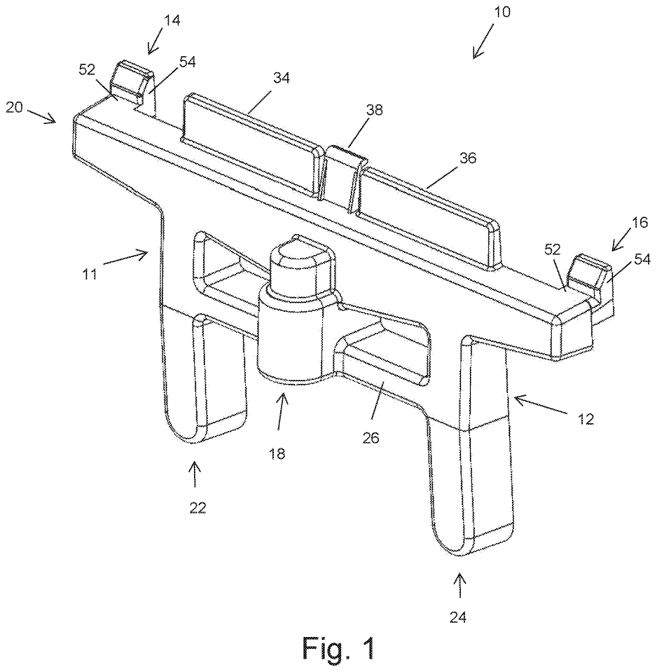

An embodiment of a mirror mount 10 of the invention is shown in FIGS. 1-7. The mount 10 comprises a body 11, a wall 12, a plurality of hooks 14, 16, and a socket 18.

The body 11 comprises the wall 12. The body 11 may take various forms. The body 11 shown in the figures comprises a first cross member 20, legs 22, 24, a second cross member 26, and tabs 34, 36. The legs 22 and 24 are spaced apart from each other and intersect each of the first cross member and the second cross member. The first cross member 20 extends laterally beyond the legs 22, 24 to form first and second wings 27, 28. Apertures 30, 32 may be formed on opposite lateral sides of the socket 18 between the first and second cross members 20, 26 and the legs 22, 24. A plurality of tabs 34, 36 are joined to the top of the first cross member. Between the tabs 34, 36 is a retainer clip 38 joined to the top of the first cross member 20. A lip 39 of the retainer clip 38 faces and is opposite the hooks 14, 16.

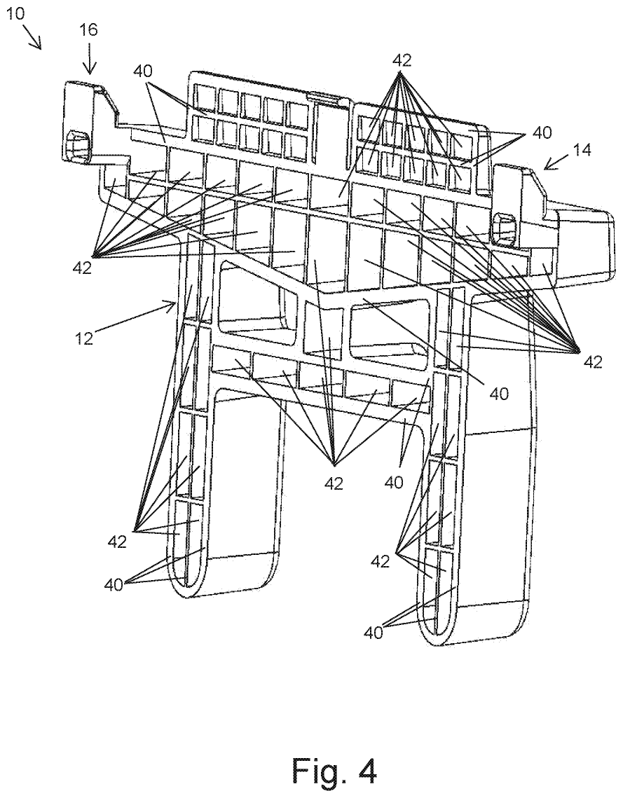

The wall 12 may be solid (not shown) or may comprise a plurality of contact surfaces 40 and a plurality of recesses 42 (not all recesses are labeled) as shown in FIGS. 3 and 4. The contact surfaces 40 may form a contact grid for receiving contact from a mirror. The contact surfaces each reside in a common plane. In some embodiments, the recesses 42 may be provided to reduce weight, as well as reduce the material quantity required for manufacture of the mount 10.

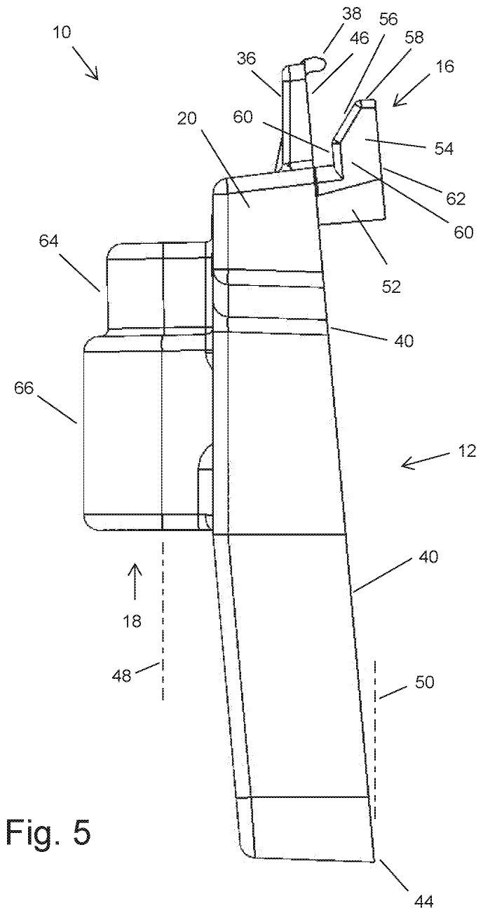

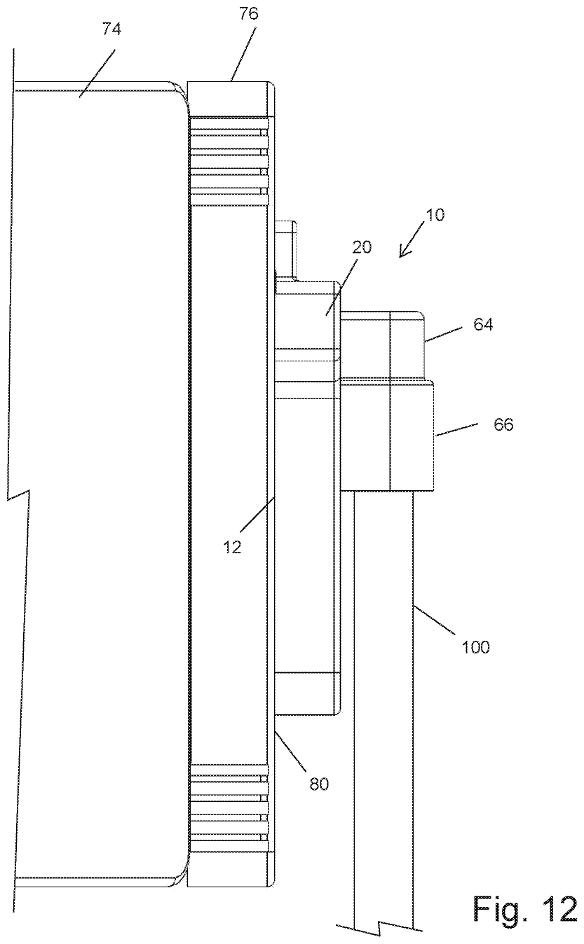

In some embodiments, the wall 12 and therefore the contact surfaces 40 are angled rear ward from a bottom 44 of the wall 12 to a top 46 of the wall, as shown in FIG. 5. The common plane of the wall 12 and the contact surfaces is angled toward centerline 48 of the socket from a bottom 44 toward the top 46 of the wall 12. Therefore, the wall and the contact surfaces are non-parallel to the centerline 48 of the socket 18. In some embodiments, the wall and the contact surfaces are angled in the range of greater than zero to about five degrees, and preferably 5 degrees, from a vertical plane 50 and from the centerline 48 of the socket. The vertical plane 50 is parallel to the centerline 48. This angle in the range of greater than zero to about 5 degrees may be provided to substantially vertically align a mirror 70 where the stand 72 may not be completely vertical under the load of the mirror 70, due to, for example, tolerances or play between components of the stand. The vertical plane 50 is shown aligned to intersect with the bottom 44 of the wall 12. Therefore, in some embodiments, the wall 12 is non-parallel and non-perpendicular to the centerline 48 of the socket. In some embodiments, the angle is zero degrees and the wall 12 is parallel to the centerline 48 of the socket 18 such as shown in FIG. 12. Therefore, the wall may be angled in the range of zero degrees to about five degrees from a vertical plane 50 and from the centerline 48 of the socket.

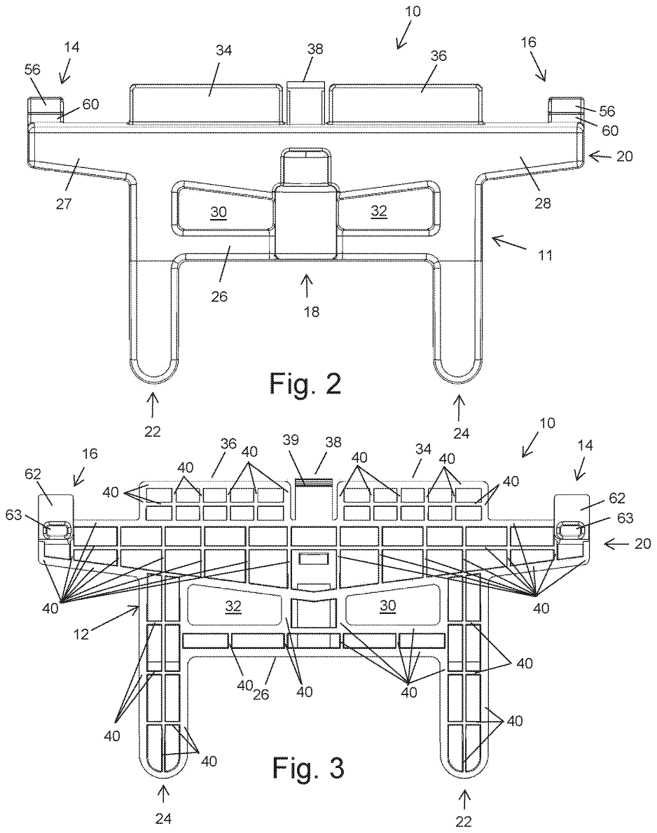

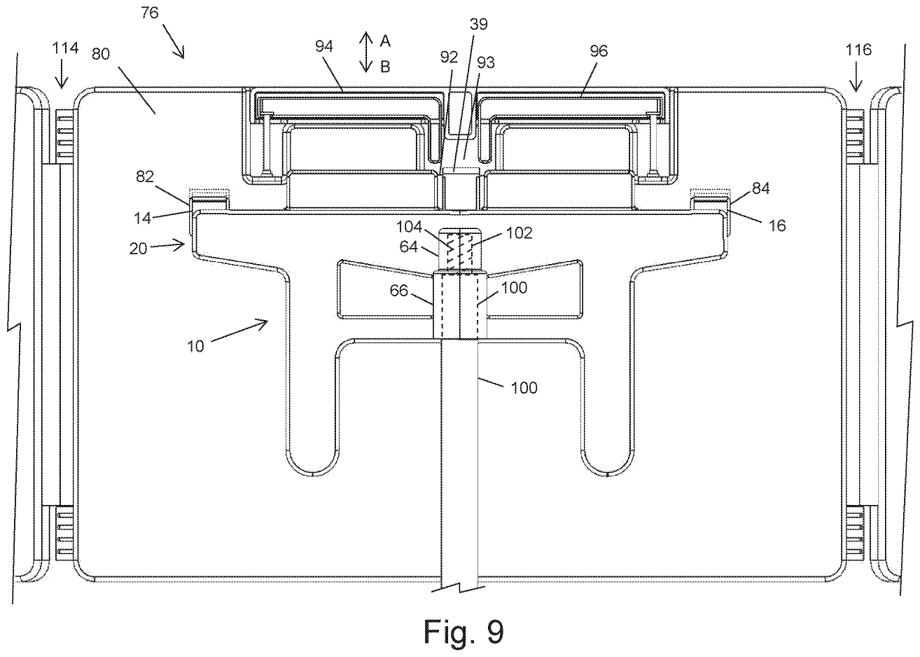

The hooks 14, 16 are in front of and extend from the wall 12 opposite of the socket 18. The hooks 14, 16 are identical and each comprise a first segment 52 and a second segment 54. The first segment is connected and transverse to the second segment. The second segment 54 is off-set from the wall 12, as shown in FIG. 5. In some embodiments, the second segment 54 is perpendicular to the first segment 52. The second segment may comprise a bevel 56 between a terminal end 58 and a proximal portion 60. The proximal portion 60 intersects the first segment 52. The bevel increases the ease of insertion of the hooks into corresponding receptacles 82, 84 (FIG. 9) on the back 80 of the mirror 70. A front wall 62 of the hooks 14, 16 may be parallel to the wall 12. The front wall 62 may comprise apertures 63, shown in FIG. 3, which may reduce overall weight of and facilitate molding, such as injection molding, of the mount 10. The hooks 14, 16 are horizontally aligned with each other as shown in FIGS. 2, 3, and 5. In some embodiments, the hooks 14, 16, are above the socket 18.

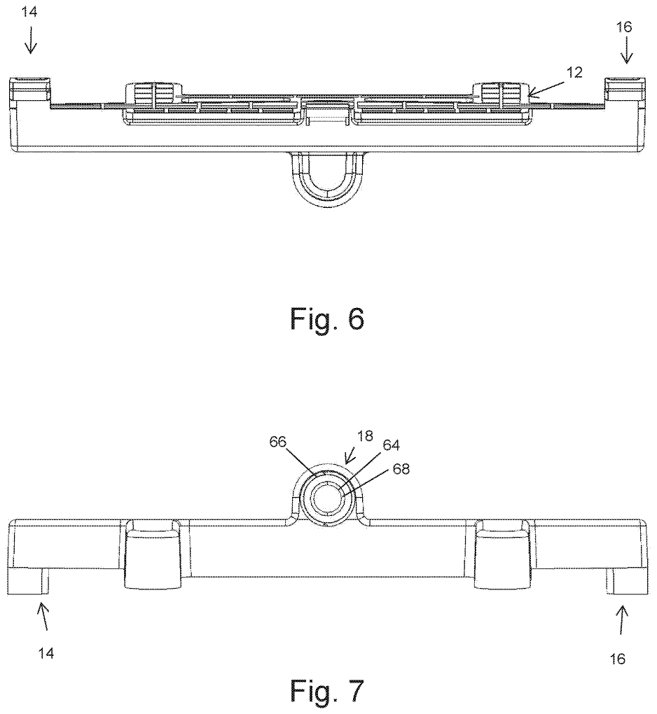

As shown in FIG. 6 the socket 18 comprises first portion 64 and a second portion 66. In some embodiments, each of the first portion and second portion are cylindrical. The first portion 64 may comprise internal circumferential threads 68 for engaging cooperating threads 104 of an end portion 102 a post 100 of the stand 72, as shown in FIG. 9. The first and second portions 64, 66 are concentric with each other and offset from each other along the centerline 48. The first portion 64 has an internal diameter that is smaller than the internal diameter of the second portion 66. The internal diameter of the second portion 66 may be sized to receive an outside diameter of the post 100, such as shown in FIG. 9.

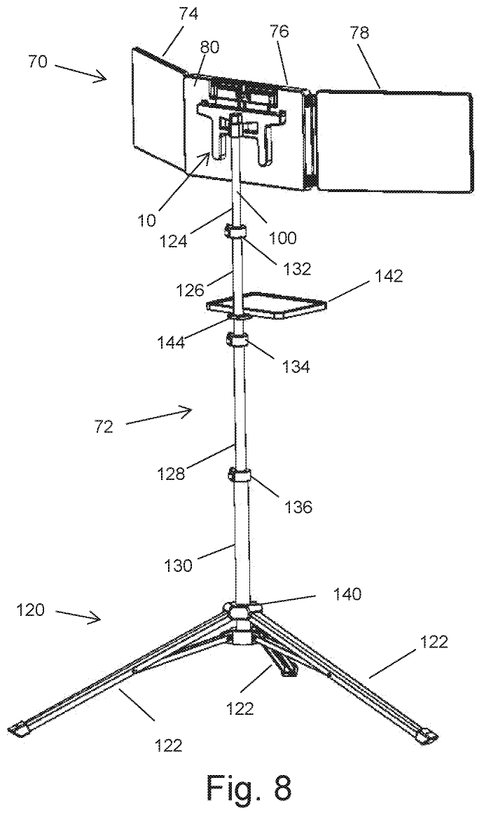

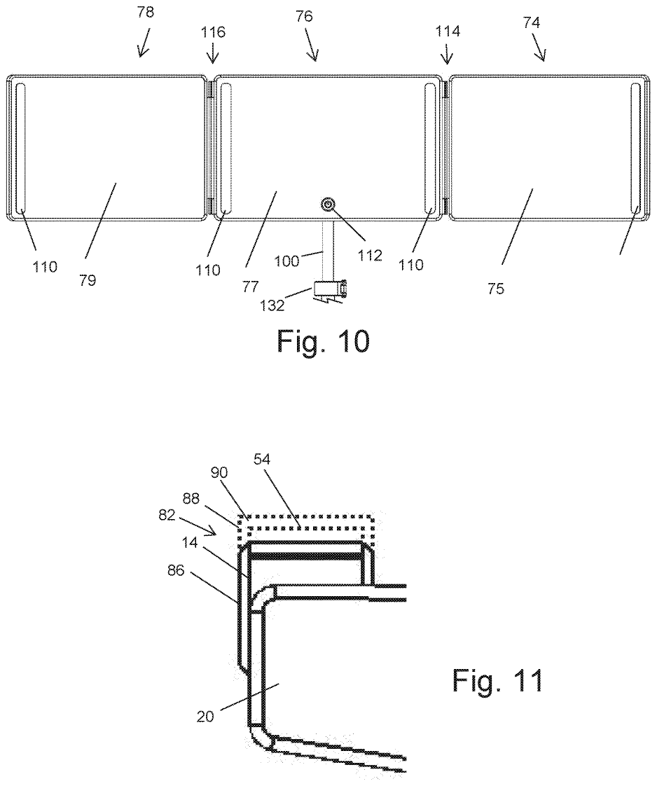

FIGS. 8 and 9 shows the mount 10 deployed to join a mirror 70 to a stand 72. The mirror 70 is shown as tri-pane mirror with three mirror panels 74, 76, 78, but other mirrors could be used, including mirrors with fewer or more panels. The front of each panel 74, 76, 78 has a reflective mirror surface 75, 77, 79, as shown in FIG. 10, preferably configured to clearly reflect an image of what is in front of the surface 75, 77, 79, respectively. The back 80 of the central panel 76 comprises receptacles 82, 84. The hooks 14, 16 are configured to engage the receptacles 82, 84 to hold and support the mirror 70. Each of the receptacles 82, 84 may be identical. Receptacle 82 is shown in detail in FIG. 10. Each receptacle comprises an aperture 86 and a cavity 88 extending above the aperture 86. At least a portion of the second segment 54, such as bevel 56 and/or portion 60, may bear against an interior side of the wall 90 providing a boundary to the cavity 88 above the aperture 86 when the hook 14, 16 is in the corresponding receptacle 82, 84.

A method of joining the mount to a mirror comprises the following. The hooks 14, 16 are aligned with the receptacles 82, 84. The hooks 14, 16, are placed into the corresponding receptacle. The mount and/or the mirror may be angled so that the wall 12 and the back 80 of the mirror are not parallel, such that the bottom 44 of the wall 12 is further from the back of the mirror than the top 46 of the wall 12. Then hooks are placed in the receptacles. Once the hooks are in the receptacles, the mirror and/or the mount is tilted about the hooks so that the wall, including the bottom 44 contacts the back 80 of the mirror 70. The hooks 14, 16 support the mirror, including providing vertical support. And, the wall 12 supports the mirror, including providing lateral stability to the mirror.

When the mount 10 is deployed on the back of the mirror 70, a lip 39 of the retainer clip 38 is engaged or positioned to engage recess wall 92 to prevent the mirror from moving up in the direction A of FIG. 11 and receptacles 82, 84 withdrawing, with the mirror in the direction A (FIG. 9), from the hooks 14, 16. Therefore the clip prevents the mirror from disconnecting from the mount in at least one direction A opposite of the hooks. The clip 38 has sufficient flex to allow a user to move the clip back away from the mirror and the common plane of the wall 12 sufficient for the recess wall 92 to clear the lip 39 and to allow the mirror to be disconnected upward in the direction A from the mount and/or the mount to be disconnected downward in the direction B away from the mirror.

When disconnecting the mount 10 from the mirror 70, the mount and or mirror may be tilted so that the bottom 44 of the wall 12 is further from the back 80 than the top 46 of the wall 12 of the mount. Then the hooks 14, 16 can be withdrawn from the cavity 88 via the aperture 86 of each respective receptacle 82, 84 and out of the respective receptacles 82, 84.

A hook housing 93 of the back 80 of the mirror comprises the recess wall 92. The hook housing may contain vertically telescoping hooks 94, 96 of the mirror for alternative mounting of the mirror on a door or other item.

The front side of the mirror may comprise lights 110, which may be vertically elongated. The lights are connected to a power source, such as a battery (not show), and to a switch 112. The switch controls the illumination of the lights. The panels 74, and 78 are pivotally connected to the central panel 74 by hinges 114, 116, which allow the outer panels 74, 76 to fold over the central panel 74 in a closed and compact configuration. For example, panel 74 may be folded closed via the hinge 114 over the surface 77 of the central panel 74, and panel 78 may be folded closed via hinge 116 over the back side of panel 74 so that the panels 74, 76, 78 are overlapped and co-extensive or substantially co-extensive with each other and the mirror is closed in a compact configuration. The mirror may be opened in the reverse order pivoting panel 78 away from panels 74 and 76 via hinge 116 and then pivoting panel 74 away from panel 76 via hinge 114 to an open and laterally expanded configuration shown in FIGS. 8 and 10. Panels 74 and 78 may be adjusted relative to panel 76 about hinges 114, 116 so that the user can achieve a desired view of himself or herself or another object in front of the mirror 70. In one application, the mirror 70 may be useful for self-grooming, such as self-haircuts.

In some embodiments, the stand 72 comprises the post 100 and a base 120. The base may comprise a plurality of legs 122, such as three legs, or a platform (not shown). The base may be supported on the floor, ground, or other surface. The post 100 may comprise a plurality of telescoping post segments 124, 126, 128, 130. The adjacent post segments' vertical telescoped position relative to each other can be set or adjusted by a respective clamp 132, 134, 136. Therefore, the height of the post 100 and therefore the height of the attached mirror 70 via the mount 10 can be adjusted by adjusting the height of one or more or all of the segments 124, 126, 128 and can be set via the respective clamps. The legs 122 can be moved between an expanded position shown in FIG. 8 and a retracted position (not shown). To move to a retracted position, the clamp 140 is released and the clamp 140 and the respective legs are slid upward along segment 130 until the legs are retracted adjacent or substantially parallel to segment 130, then the clamp 140 can be tightened to hold the legs in the retracted position. The legs can be moved to the deployed position shown in FIG. 8 by moving the clamp down segment 130 which will extend the legs away from segment 130 as the clamp 140 and proximal ends of the legs move down along segment 130. A tray 142 may be releasably fixed via clamp 144 along one or more of the segments 124, 126, 128, 130, such as shown in FIG. 8. The tray may be used to hold items, such as grooming items adjacent the mirror for use by the user.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. Further, steps could be added or removed from the processes described. Therefore, other embodiments and implementations are within the scope of the invention.

The invention claimed is:

1. A mirror mount, comprising:
a wall configured to contact a back of a mirror;
a plurality of hooks on a front side of the wall; and,
a socket behind the wall and configured to connect to a stand.

2. The mirror mount of claim 1, wherein each of the plurality of hooks comprise a first segment and a second segment, the first segment is transverse to the wall, the second segment is spaced from the wall and is transverse to the first segment.

3. The mirror mount of claim 2, wherein the first segment is perpendicular to the second segment.

4. The mirror mount of claim 1, wherein the wall comprises a contact grid comprising a plurality of apertures.

5. The mirror mount of claim 1, wherein the wall is non-parallel and non-perpendicular to a centerline of the socket.

6. The mirror mount of claim 1, wherein the wall is parallel to a centerline of the socket.

7. The mirror mount of claim 1, wherein the wall is angled about five degrees from a centerline of the socket.

8. The mirror mount of claim 1, wherein the socket comprises an interior circumferential wall comprising threads.

9. The mirror mount of claim 1, wherein the socket comprises a first portion and a second portion, an interior diameter of the first portion is smaller than an interior diameter of the second portion, the first portion is concentric and offset from the second portion.

10. The mirror mount of claim 1, comprising a retaining clip above the plurality of hooks, a lip of the retaining clip is opposite of the plurality of hooks.

11. The mirror mount of claim 1, wherein the plurality of hooks are horizontally aligned and are spaced apart from each other.

12. The mirror mount of claim 1, wherein
each of the plurality of hooks comprise a first segment and a second segment, the first segment is transverse to the wall, the second segment is spaced from the wall and is transverse to the first segment;
the plurality of hooks intersect the wall, are horizontally aligned, are spaced apart from each other, and are above the socket;
the wall is non-parallel and non-perpendicular to a centerline of the socket;
the socket comprises a first portion and a second portion, an interior diameter of the first portion is smaller than an interior diameter of the second portion, the first portion is concentric and offset from the second portion, the first portion comprises an interior circumferential wall comprising threads; and,
the mirror mount comprises a retaining clip above the plurality of hooks, a lip of the retaining clip is opposite of the plurality of hooks.

13. A mirror stand, comprising:
a base;
a post supported by the base; and,
a mount comprising a socket, the post received in the socket, the mount comprising
a wall configured to contact a back of a mirror;
a plurality of hooks on a front side of the wall; and,
the socket is behind the wall.

14. The stand of claim 13, wherein each of the plurality of hooks comprise a first segment and a second segment, the first segment is transverse to the wall, the second segment is spaced from the wall and is transverse to the first segment.

15. The stand of claim 13, wherein the wall is non-parallel and non-perpendicular to a centerline of the socket.

16. The stand of claim 13, wherein the wall is parallel to a centerline of the socket.

17. The stand of claim 13, wherein
each of the plurality of hooks comprise a first segment and a second segment, the first segment is transverse to the wall, the second segment is spaced from the wall and is transverse to the first segment;
the plurality of hooks intersect the wall, are horizontally aligned, are spaced apart from each other, and are above the socket;
the wall is non-parallel and non-perpendicular to a centerline of the socket;
the socket comprises a first portion and a second portion, an interior diameter of the first portion is smaller than an interior diameter of the second portion, the first portion is concentric and offset from the second portion, the first portion comprises an interior circumferential wall comprising threads; and,
the mount comprises a retaining clip above the plurality of hooks, a lip of the retaining clip is opposite of the plurality of hooks.

18. A method of mounting a mirror to a stand, comprising:
placing a plurality of hooks of a mount of the stand in a plurality of receptacles in a back of the mirror; and,
placing the back of the mirror against a wall of the mount; and,
retaining the mirror on the plurality of hooks with a clip of the mount opposite the hooks engageable with the back of the mirror.

19. The method of claim 18, comprising threading a socket of the mount on a post of the stand.
